(19) United States
(12) Patent Application Publication
(10) Pub. No.: US 2012/0075489 A1
(43) Pub. Date: Mar. 29, 2012

(54) ZOOM CAMERA IMAGE BLENDING TECHNIQUE

(76) Inventor: H. Keith Nishihara, Los Altos, CA (US)

(21) Appl. No.: 12/889,675

(22) Filed: Sep. 24, 2010

(51) Int. Cl. H04N 5/228; G06K 9/36

(52) U.S. Cl. 348/222.1; 382/284; 348/E05.033

(57) ABSTRACT

In a digital picture created by combining an outer zone from a first lens and an inner zone from a second lens, the two zones may be blended together in an intermediate zone created by processing pixels from both the outer and inner zones. The blending may be performed by creating pixels in the intermediate zone that are progressively less influenced by pixels from the first lens and progressively more influenced by pixels from the second lens, as the location of the intermediate pixels transitions from the outer zone to the inner zone. Image registration may be used to achieve the same scale before blending.

### BACKGROUND

A technique has been developed for producing a zoom camera image by processing and combining the images from two lenses with two different fixed focal lengths or fields of view (see International patent application PCT/US2009/069804, filed Dec. 30, 2009). The image from the longer focal length (e.g., narrow field) lens may produce the central part of the final image, while the shorter focal length (e.g., wide field) lens may produce the remainder of the final image. Digital processing may adjust these two parts to produce a single image equivalent to that from a lens with an intermediate focal length. While this process may enable two fixed lenses to emulate the effect of a zoom lens, the line of demarcation between the two portions of the final image may be visible and distracting.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a device with two lenses having different fields of view, according to an embodiment of the invention.

FIGS. 2A, 2B show how an image may be constructed from the original images received from each lens, according to an embodiment of the invention.

FIGS. 3A, 3B show measurements within the intermediate zone, according to an embodiment of the invention.

FIG. 4 shows a flow diagram of a method of blending pixels in a composite image, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a computer-readable medium, which may be read and executed by one or more processors to enable performance of the operations described herein. A computer-readable medium may include any mechanism for storing information in a form readable by one or more computers. For example, a computer-readable medium may include a tangible storage medium, such as but not limited to read only memory (ROM); random access memory (RAM); magnetic disk storage media; optical storage media; a flash memory device, etc.

Various embodiments of the invention pertain to a blending technique used on an image created from a first digitized image from a fixed lens with a narrow field of view (referred to herein as a ‘narrow field lens’) and a second digitized image from a fixed lens with a wide field of view (referred to herein as a ‘wide field lens’). In this document, the terms ‘narrow’ and ‘wide’ are meant to be relative to each other, not to any external reference or industry standard. Within this document, an ‘image’ is a collection of pixel values that represent a visual picture. The pixels are typically thought of as being arranged in a rectangular array to achieve an easily understood correspondence between the image and the picture, but other embodiments may use other arrangements of pixels. Even if the image is not being displayed, processing the pixels may be described as if the image were being displayed, with terms such as ‘inner’, ‘outer’, ‘zoom’, ‘reduced’, ‘enlarged’, etc., describing how processing this data would effects the visual picture if it were displayed.

Once images have been obtained from both lenses, with all or at least a portion of the scene depicted by the narrow field lens being a subset of the scene depicted by the wide field lens, a composite image may be formed by using pixels from the narrow field image to form an inner portion (e.g., a central portion) of the composite, and using pixels from the wide field image to form an outer portion of the composite. The inner and outer portions may overlap to form an intermediate portion. Pixels within this intermediate portion may be derived by processing pixels from the narrow field image with the associated pixels from the wide field image, to gradually transition from the inner portion to the outer portion in a way that reduces visual discontinuities between the inner and outer portions.

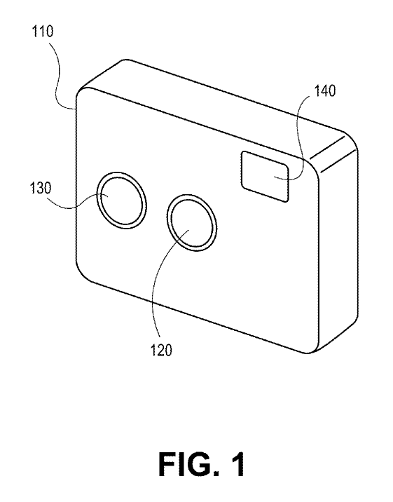

FIG. 1 shows a device with two lenses having different fields of view, according to an embodiment of the invention. In some embodiments device 110 may be primarily a camera, while in other embodiments device 110 may be a multi-function device that includes the functionality of a camera. Some embodiments may also include a light source 140 (e.g., a flash) to illuminate the scene being photographed. Although the lenses 120 and 130 are shown in particular locations on the device 110, they may be located in any feasible places. In a preferred embodiment each lens may have a fixed field of view, but in other embodiments at least one of the lenses may have a variable field of view. In some embodiments, the optical axes of both lenses may be approximately parallel, so that the image from each lens will be centered at or near the same point in the scene. Alternately, the narrow field image may be centered on a part of the scene that is not in the center of the wide field image. Digital images captured through the two lenses may be combined and processed in a manner that emulates an image captured through a lens with an intermediate field of view that is between the fields of view of the two lenses. Through proper processing, this combined image may emulate an image produced by a zoom lens with a variable field of view. Another advantage of this technique is that the final image may show more detail in certain portions of the picture than would be possible with the wide field lens alone, but will still encompass more of the initial scene that would be possible with the narrow field lens alone.

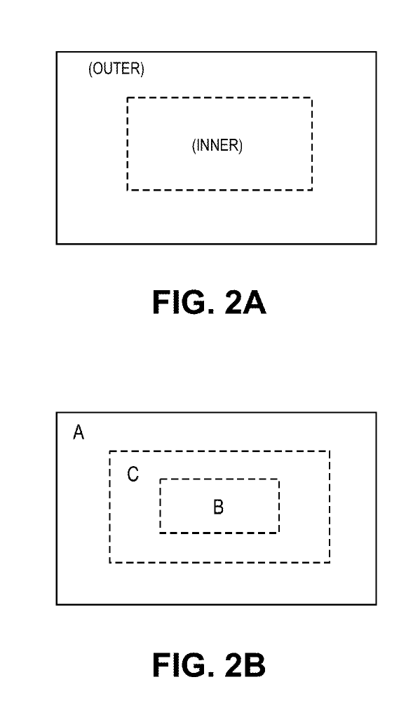

FIGS. 2A, 2B show how a composite image may be constructed from the two original images received from each lens, according to an embodiment of the invention. In some embodiments the original images may be individual still images, but in other embodiments, individual frames from a video sequence may be used. The actual scene being viewed is omitted from these figures to avoid excessive clutter in the drawings, and only the various areas of the image are shown. In FIG. 2A, the outer portion of the image may be derived from the wide field lens, while the inner portion of the image may be derived from the narrow field lens. Since the ‘scale’ of the two initial images is different (e.g., an object in the scene captured with the wide field lens will appear smaller than the same object captured with the narrow field lens), the two images may be registered to achieve the same scale. ‘Image registration’, as used herein, involves cropping the wide field image and upsampling the remaining pixels to increase the number of pixels used to depict that part of the scene. In some embodiments, image registration may also involve downsampling the narrow field image to decrease the number of pixels used to depict that part of the scene. The term ‘resampling’ may be used to include upsampling and/or downsampling. When a given object in the scene is depicted by approximately the same number of pixels in both images, the two images may be considered registered. In embodiments in which both lenses have a fixed field of view, the amount of cropping and resampling may be predetermined. If either or both lenses have a variable field of view, the amount of cropping and resampling may be variable. Once registered, pixels from the two images may be combined to form a composite image by using the pixels from the registered narrow field image to form an inner portion of the composite image, and using pixels from the registered wide field image to form an outer portion of the composite image. The composite image should then depict a continuous scene at the same scale throughout. However, because of various optical factors related to resampling and/or the fact that different light sensors may have been used to acquire each of the images, discontinuities between the two portions may be visible at the border between the inner and outer portions (shown as a dashed line). These discontinuities may be in the form of misalignment, and/or differences in color, brightness, and/or contrast.

As shown in FIG. 2B, an intermediate portion may be created by making the initial inner and outer portions overlap, and using the overlapped area as the intermediate portion. Then the composite image may consist of an outer zone A with pixels derived from the wide field image (through cropping and upsampling), an inner zone B with pixels derived from the narrow field image (with or without cropping and/or downsampling), and an intermediate zone C with pixels derived from a combination of pixels from both the wide and narrow field images (after those pixels have been cropped and/or resampled, if appropriate). The portion of the image in this intermediate zone may then be ‘blended’ to make a gradual transition from the outer zone to the inner zone. Within this document, the term ‘blended’ indicates creating final pixel values by making a gradual transition by changing the relative influence of the pixels derived from the narrow field image and pixels derived from the wide field image. If such blending takes place over a sufficiently large spatial distance, then differences in alignment, color, brightness, and contrast may become difficult to detect by the human eye and therefore unnoticeable.

The sizes of the intermediate zone, the inner zone, and the outer zone, relative to each other, may depend on various factors, and in some embodiments may be dynamically variable. In other embodiments, these relative sizes may be fixed. The intermediate zone is shown as having a hollow rectangular shape, but may have any other feasible shape, such as but not limited to an annular ring. In some embodiments, each pixel in the intermediate zone may be processed individually, while in other embodiments, multi-pixel groups may be processed together. In some embodiments that contain multi-element pixels (e.g., color pixels consisting of red, blue, and green elements or yellow, magenta, and cyan elements), each element may be processed separately from the other elements in that pixel. Within this document, including the claims, any processing that is described as being performed on a pixel may be performed separately on individual elements within a pixel, and that element-by-element process shall be encompassed by the description and/or claim.

In one embodiment, each pixel in the intermediate zone that is close to the inner zone may be processed so as to result in a value nearly identical to the value it would have if it were in the inner zone (i.e., derived solely from the narrow field image). In a similar manner, each pixel in the intermediate zone that is close to the outer zone may be processed so as to result in a value nearly identical to the value it would have if it were in the outer zone (i.e., derived solely from the wide field image). As each pixel's location is farther from the inner zone and closer to the outer zone, it may be processed in a way that is influenced less by the pixel derived from the narrow field image and more by the associated pixel derived from the wide field image.

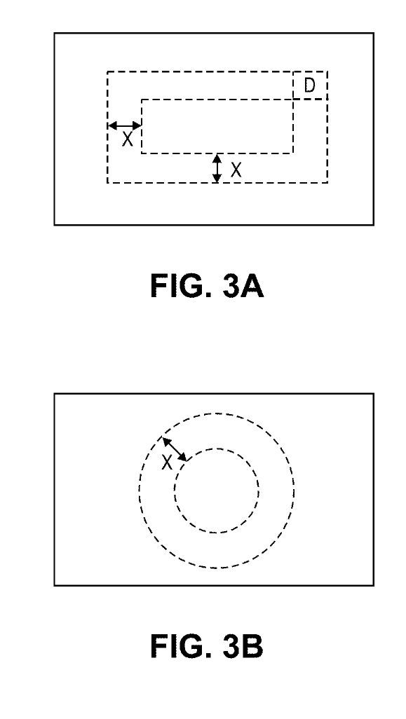

FIGS. 3A, 3B show measurements within the intermediate zone, according to an embodiment of the invention. In one embodiment, a formula for producing a value for each pixel in the intermediate zone may be:

Pf=(X*Pw)+(1−X)*Pn

where Pf is the final pixel value,

Pw is the associated pixel value derived from the wide field image,

Pn is the associated pixel value derived from the narrow field image, and

X is a value between 0 and 1 that is related to the relative spatial position of the pixel between the inner zone and outer zone. In one embodiment, X may vary linearly across the distance from the inner zone to the outer zone (i.e., represent the fractional distance), while in other embodiments it may vary non-linearly (e.g., change more slowly or quickly near the borders of the intermediate zone than in the middle portions of that zone).

In this example, X=0 at the border between the inner and intermediate zones, while X=1 at the border between the outer and intermediate zones.

In some embodiments (e.g., where the intermediate zone has a hollow rectangular shape as in FIG. 3A), X may indicate relative horizontal or vertical distance. Adjustments may need to be made in the corners (e.g., “D”) by considering both horizontal and vertical measurements to determine a value for X. In other embodiments (e.g., where the intermediate zone is annular as in FIG. 3B), X may indicate relative radial distance from the center. In some embodiments, X may vary linearly with the distance from the inner zone to the outer zone. In other embodiments, X may vary non-linearly with that distance. In some embodiments, X may vary in a different manner for different elements (e.g., different colors) of multi-element pixels. These are just some of the ways the value of X may be determined for a particular pixel in the intermediate zone. The primary consideration is that X indicates relative position of each pixel as measured across the intermediate zone between the inner and outer zones.

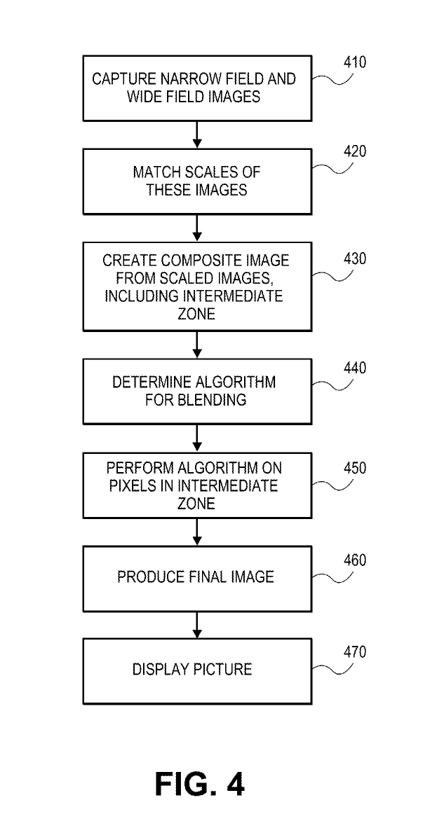

FIG. 4 shows a flow diagram of a method of blending pixels in a composite image, according to an embodiment of the invention. In the illustrated embodiment, at 410 the device may capture two images, one through a narrow field lens and one through a wide field lens, with at least a portion of the scene captured by the narrow field lens being a subset of the scene captured by the wide field lens. In some embodiments, both images may be stored in a non-compressed digitized format to await further processing.

At 420 the scale of the two images may be adjusted so that they both reflect the same scale. For example, the previously described method of image registration, through cropping and resampling, may be used so that a given portion of the scene from one image is represented by approximately the same number of pixels as it is in the other image. In some instances, only the wide field image may be cropped/upsampled in this manner. In other instances, the narrow field image may also be cropped and/or downsampled. To decide how much to crop and resample, in some embodiments it may be necessary to first determine the field of view and pixel dimensions of the final image. In other embodiments this may be predetermined.

At 430 a composite image may be created by combining the outer portion of the modified wide field image with the (modified or unmodified) narrow field image. These two portions may be defined such that they overlap to form an intermediate zone containing corresponding pixels from both. In some embodiments the size and location of this intermediate zone may be fixed and predetermined. In other embodiments the size and/or location of this intermediate zone may be variable, and determined either through an automatic process or by the user.

At 440 an algorithm may be determined for blending the pixels in the intermediate zone. In some embodiments there will only be one algorithm, and this step may be skipped. In other embodiments, there may be multiple algorithms to select from, either automatically or by the user. In some embodiments, multiple algorithms may be used during the same processing, either in parallel or sequentially.

At 450 the algorithm(s) may be used to process the pixels in the intermediate zone. In combination with the pixels in the inner and outer zones, these pixels may then produce the final image at 460. At 470, this final image may then be converted to a picture for display on a screen (e.g., for viewing by the person taking the picture), but the final image may alternately sent to a printer, or simply saved for use at a later time. In some embodiments, the user may examine the final image on the device's display and decide if the image needs further processing, using either the same algorithm(s) or different algorithm(s).

In some situations, the blending process described here may not produce a satisfactory improvement in the final image, and if that determination can be predicted, a decision may be made (either automatically or by a user) not to use a blending process. In some situations, merging the wide field image and the narrow field image (with or without blending) may not produce a satisfactory improvement in the final image, and a decision may be made (either automatically or by a user) not to combine those two initial images. If either of these situations is true, then one of the initial images may be used as is, one of the initial images may be modified in some way, or neither image may be used.

The foregoing description is intended to be illustrative and not limiting. Variations will occur to those of skill in the art. Those variations are intended to be included in the various embodiments of the invention, which are limited only by the scope of the following claims.

What is claimed is:

1. A method, comprising:
creating a digital image by combining an outer zone of pixels derived from a first image from a first lens, an inner zone of pixels derived from a second image from a second lens, and an intermediate zone of pixels located between the outer and inner zones, the intermediate zone containing pixels produced by processing pixels derived from both the first and second images;
wherein the pixels in the intermediate zone are blended between the inner and outer zones.

2. The method of claim 1, wherein the intermediate zone has an annular shape.

3. The method of claim 1, wherein the intermediate zone has a hollow rectangular shape.

4. The method of claim 1, wherein pixels in the intermediate zone are processed with a formula equivalent to Pf=(X*Pw)+(1−X)*Pn, where Pw represents a pixel value from the wide field lens, Pn represents a pixel value from the narrow field lens, X is related to a relative spatial position of Pf between the inner zone and outer zone, and 0<X<1.

5. The method of claim 1, wherein:
each pixel in the intermediate zone contains multiple elements; and each element in a particular pixel is processed separately from other elements in the particular pixel.

6. The method of claim 1, wherein the first lens is a wide field lens, and the second lens is a narrow field lens.

7. An apparatus, comprising:
a device having a processor, a memory, an optical sensor, a wide field lens, and a narrow field lens, the device to:
receive a first image of a scene through the wide field lens and a second image of a portion of the scene through the narrow field lens;
crop and downsample the first image to produce a third image;
process the second image to produce a fourth image, wherein objects in the third image have a same scale as the same objects in the fourth image;
combine an outer portion of the third image with the fourth image to form a composite image, wherein part of the third image overlaps part of the fourth image to form an intermediate zone; and
within the intermediate zone, process each pixel from the third image with a corresponding pixel from the fourth image to produce a final pixel in the intermediate zone;
wherein said processing each pixel comprises blending.

8. The apparatus of claim 7, wherein the intermediate zone has an annular shape.

9. The apparatus of claim 7, wherein the intermediate zone has a hollow rectangular shape.

10. The apparatus of claim 7, wherein at least some pixels in the intermediate zone are processed with a formula equivalent to Pf=(X*Pw)+(1−X)*Pn, where Pw represents a pixel value from the third image, Pn represents a corresponding pixel value from the fourth image, X is related to a relative spatial position of Pf between inner and outer boundaries of the intermediate zone, and 0<X<1.

11. The apparatus of claim 7, wherein:
each pixel in the intermediate zone contains multiple elements; and
each element in a particular pixel is processed separately from other elements in the particular pixel.

12. The apparatus of claim 7, wherein the device includes a radio for wireless communications.

13. An article comprising
a computer-readable storage medium that contains instructions, which when executed by one or more processors result in performing operations comprising:
creating a digital image by combining an outer zone of pixels derived from a first image from a first lens, an inner zone of pixels derived from a second image from a second lens, and an intermediate zone of pixels located between the outer and inner zones, the intermediate zone containing pixels produced by processing pixels derived from both the first and second images;
wherein the pixels in the intermediate zone are blended between the inner and outer zones.

14. The article of claim 13, wherein the intermediate zone has an annular shape.

15. The article of claim 13, wherein the intermediate zone has a hollow rectangular shape.

16. The article of claim 13, wherein pixels in the intermediate zone are processed with a formula equivalent to Pf=(X*Pw)+(1−X)*Pn, where Pw represents a pixel value from the wide field lens, Pn represents a pixel value from the narrow field lens, X is related to a relative spatial position of Pf between the inner zone and outer zone, and 0<X<1.

17. The article of claim 13, wherein:
each pixel in the intermediate zone contains multiple elements; and
each element in a particular pixel is processed separately from other elements in the particular pixel.

18. The article of claim 13, wherein the first lens is a wide field lens, and the second lens is a narrow field lens.
